(19) United States
(12) Patent Application Publication
(10) Pub. No.: US 2012/0108212 A1
(43) Pub. Date: May 3, 2012

(54) Monitoring System For Mobile Terminal And Monitoring Method Thereof

(75) Inventor: Hai Zhao, Guangdong (CN)

(73) Assignee: HUIZHOU TCL MOBILE COMMUNICATION CO.,LTD, Huizhou City, Guangdong (CN)

(21) Appl. No.: 13/381,946

(22) PCT Filed: Dec. 16, 2010
(86) PCT No.: PCT/CN2010/079903

§ 371 Date: Dec. 31, 2011

(30) Foreign Application Priority Data
Jun. 8, 2010 (CN) 201010201582.1

(51) Int. Cl. H04W 24/00; H04W 12/00; H04B 17/00

(52) U.S. Cl. 455/411; 455/67.11

(57) ABSTRACT

A monitoring system for a mobile terminal is disclosed in the present disclosure. The monitoring system comprises: a monitoring mobile terminal, being configured to send monitoring request information; and at least one monitored mobile terminal, being configured to receive the monitoring request information and send a corresponding monitoring report to the monitoring mobile terminal according to the monitoring request information. The monitoring mobile terminal and the monitored mobile terminal are connected wirelessly. Because the monitoring mobile terminal is configured to send monitoring request information and the monitored mobile terminal is configured to receive the monitoring request information and send a corresponding monitoring report to the monitoring mobile terminal according to the monitoring request information, the monitoring system for a mobile terminal and the monitoring method thereof according to the present disclosure allow a monitor to know using conditions of the monitored mobile terminal at any time and at any place. Therefore, the monitoring system for a mobile terminal and the monitoring method thereof according to the present disclosure are simple to operate and convenient to use.

### FIELD OF THE INVENTION

The present disclosure generally relates to the technical field of mobile phone monitoring, and more particularly, to a monitoring system for a mobile terminal and a monitoring method thereof.

### BACKGROUND OF THE INVENTION

As a kind of means of communication, communication terminals have brought about great convenience to people's life. Nowadays, more and more students are using mobile phones as a means of communication and, meanwhile, more and more students try to make phone calls, send short messages, chat online, play games and so on in class hours, which have adversely affected the students' study. However, because there is still no effective measure to restrict use of the communication terminals, it is impossible for parents or teachers to monitor or keep track of use of the communication terminals of the students. Consequently, abuse of the communication terminals may make an adverse impact on the students' life. Accordingly, an urgent need exists in the art to develop a monitoring system for a mobile terminal.

### SUMMARY OF THE INVENTION

A primary objective of the present disclosure is to provide a monitoring system for a mobile terminal and a monitoring method thereof that can obtain using conditions of a monitored mobile terminal at any time and at any place.

To achieve the aforesaid objective, the present disclosure provides the following technical solutions.

The present disclosure provides a monitoring system for a mobile terminal, which comprises:

a monitoring mobile terminal, being configured to send monitoring request information; and

at least one monitored mobile terminal, being configured to receive the monitoring request information and send a corresponding monitoring report to the monitoring mobile terminal according to the monitoring request information,

wherein the monitoring mobile terminal and the monitored mobile terminal are connected wirelessly.

Preferably in the monitoring system, the monitored mobile terminal comprises:

an MSM module, being configured to set a sending format and a sending time of the monitoring report; and

an SSM module, being configured to modify the setting functions of the MSM module, and

the monitored mobile terminal is also configured to send the monitoring report to the monitoring mobile terminal periodically.

Preferably in the monitoring system, the MSM module comprises:

a password control unit, being configured to set a mobile phone number or password of the monitoring mobile terminal; and

a password identifying unit, being configured to identify the mobile phone number or password.

Preferably in the monitoring system, the monitoring mobile terminal comprises:

an MSM module, being configured to set a sending format and a sending time of the monitoring report; and

an SSM module, being configured to modify the setting functions of the MSM module.

Preferably in the monitoring system, the monitoring report includes one or more of a calling party's phone number, a call duration, a short message record, a QQ chat log, a website and a networking times.

The present disclosure further provides a monitoring method for the monitoring system, which comprises the following steps of:

sending monitoring request information by the monitoring mobile terminal to the monitored mobile terminal; and

receiving the monitoring request information and sending a corresponding monitoring report to the monitoring mobile terminal according to the monitoring request information by the monitored mobile terminal.

Preferably, the monitoring method further comprises the following step before the monitoring mobile terminal sends the monitoring request information to the monitored mobile terminal:

setting a mobile phone number or password of the monitoring mobile terminal in the monitored mobile terminal.

Preferably, the monitoring method further comprises the following step after the monitoring mobile terminal sends the monitoring request information to the monitored mobile terminal:

identifying the mobile phone number or password of the monitoring mobile terminal by the monitored mobile terminal.

Preferably in the monitoring method, the monitoring report is sent to the monitoring mobile terminal in the form of a short message.

Preferably in the monitoring method, the monitoring report includes one or more of a calling party's phone number, a call duration, a short message record, a QQ chat log, a website and a networking times.

Because the monitoring mobile terminal is configured to send monitoring request information and the monitored mobile terminal is configured to receive the monitoring request information and send a corresponding monitoring report to the monitoring mobile terminal according to the monitoring request information, the monitoring system for a mobile terminal and the monitoring method thereof according to the present disclosure allow a monitor to know using conditions of the monitored mobile terminal at any time and at any place. Therefore, the monitoring system for a mobile terminal and the monitoring method thereof according to the present disclosure are simple to operate and convenient to use.

### BRIEF DESCRIPTION OF THE DRAWINGS

In order to more clearly describe the technical solutions of the embodiments of the present disclosure, attached drawings to be used in the detailed description of the disclosure will be briefly described hereinbelow. Obviously, the attached drawings described hereinbelow only illustrate some of the embodiments of the present disclosure, and those of ordinary skill in the art can also obtain other attached drawings therefrom without the need of making inventive efforts, wherein:

FIG. 1 is a block diagram illustrating a structure of a monitoring system for a mobile terminal according to the present disclosure.

FIG. 2 is a schematic structural view of the monitoring system for a mobile terminal according to an embodiment of the present disclosure.

FIG. 3 is a flowchart diagram of a monitoring method for the monitoring system according to the present disclosure.

### DETAILED DESCRIPTION OF THE INVENTION

The present invention is further described in detail below with reference to the accompanying drawings and embodiments.

The present disclosure provides a monitoring system for a mobile terminal and a monitoring method thereof, which can be used by parents to monitor use of mobile phones of students and can also be used by companies to monitor businesses of employees. The monitoring system for a mobile terminal and the monitoring method thereof are simple to operate and convenient to use.

In order to make objectives, technical solutions and advantages of the present disclosure more apparent and obvious, embodiments of the present disclosure will be further detailed hereinbelow with reference to the attached drawings. However, it shall be appreciated that, the embodiments described herein are only intended to illustrate but not to limit the present disclosure.

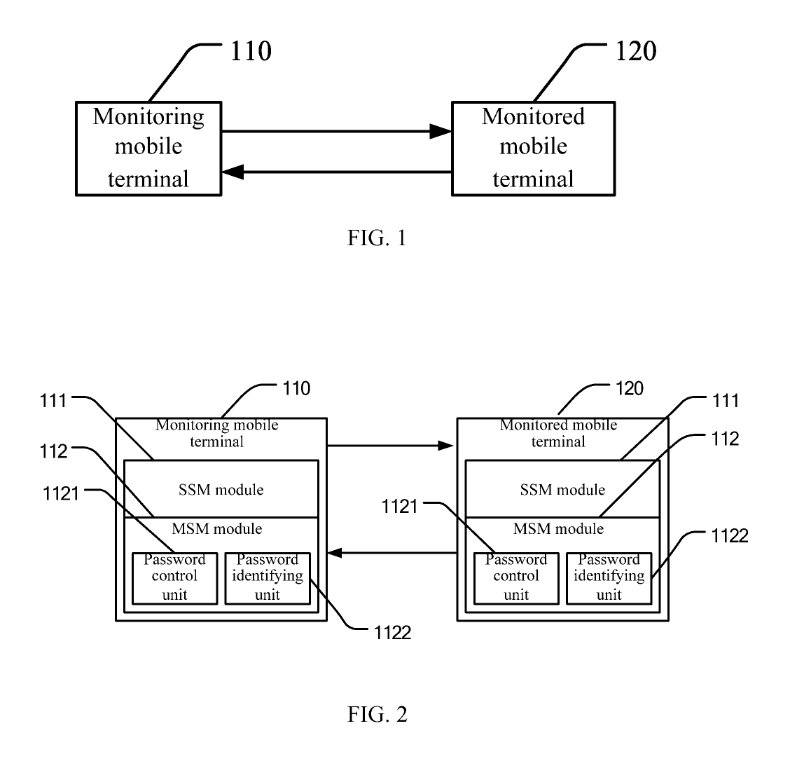

Referring to FIG. 1, the monitoring system for a mobile terminal of the present disclosure comprises a monitoring mobile terminal 110 and at least one monitored mobile terminal 120. The monitoring mobile terminal 110 is wirelessly connected to the monitored mobile terminal 120, and is configured to send monitoring request information to the monitored mobile terminal 120. There may be more than two monitored mobile terminals 120 configured to receive the monitoring request information from the monitoring mobile terminal 110 and send a corresponding monitoring report according to the monitoring request information.

The monitoring report includes one or more of a calling party's phone number, a call duration, a short message record, a QQ chat log, a website and a networking times.

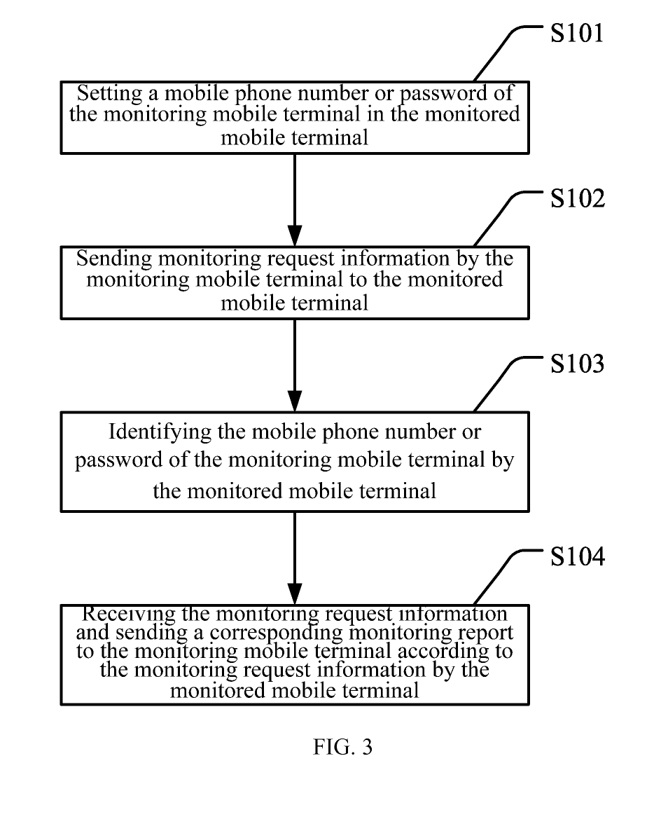

Referring to FIG. 2 together, the monitored mobile terminal 120 comprises an SSM (Supervising Software Module) module 111 and an MSM (Monitored Software Module) module 112. The MSM module 112 is configured to set a sending format and a sending time of the monitoring report; and the SSM module 110 is configured to modify the setting functions of the MSM module.

The MSM module 112 comprises a password control unit 1121 and a password identifying unit 1122. The password control unit 1121 is configured to set a mobile phone number or password of the monitoring mobile terminal; and the password identifying unit 1122 is configured to identify the mobile phone number or password.

The monitoring manner of this embodiment is an on demand (OD) monitoring manner. Of course, in other embodiments, other monitoring manners may also be used. For example, a user may set in the MSM module 112 arbitrarily a time interval at which the monitoring report is sent, so the monitored mobile terminal 120 can send the monitoring report to the monitoring mobile terminal 110 periodically without the need of sending the monitoring request information by the monitoring mobile terminal any longer.

In the monitoring system of the present disclosure, a monitor can use an existing mobile terminal while a monitored person can use the monitored mobile terminal of the present disclosure. The monitoring function of this system can be accomplished by simply setting a mobile phone number or password of the monitor in the monitored mobile terminal prior to use.

Of course, the monitoring mobile terminal in the present disclosure may also be used as a monitored mobile terminal instead; and the function of monitoring the monitoring mobile terminal can be accomplished by simply disposing an MSM module 112 and an SSM module 111 in the monitoring mobile terminal. Thus, the monitoring mobile terminal and the monitored mobile terminal can monitor each other, and both the monitor and the monitored person can know using conditions of each other's mobile terminal.

In a further embodiment, the monitoring mobile terminal is also configured to send to the monitored mobile terminal modification information for modifying the sending format and the sending time of the monitoring report as well as modification information for modifying the mobile phone number and the password of the monitoring mobile terminal; and the monitored mobile terminal is also configured to feed back an information report about whether the modification is successful to the monitoring mobile terminal according to the modification information.

On the basis of the aforesaid monitoring system for a mobile terminal, an embodiment of the present disclosure further provides a monitoring method for the monitoring system correspondingly. Referring to FIG. 3, the monitoring method comprises the following steps of:

S101: setting a mobile phone number or password of the monitoring mobile terminal in the monitored mobile terminal;

S102: sending monitoring request information by the monitoring mobile terminal to the monitored mobile terminal;

S103: identifying the mobile phone number or password of the monitoring mobile terminal by the monitored mobile terminal; and

S104: receiving the monitoring request information and sending a corresponding monitoring report to the monitoring mobile terminal according to the monitoring request information by the monitored mobile terminal, wherein the monitoring report is sent to the monitoring mobile terminal in the form of a short message.

Because the monitoring mobile terminal is configured to send monitoring request information and the monitored mobile terminal is configured to receive the monitoring request information and send a corresponding monitoring report to the monitoring mobile terminal according to the monitoring request information, the monitoring system for a mobile terminal and the monitoring method thereof according to the present disclosure allow a monitor to know using conditions of the monitored mobile terminal at any time and at any place. Moreover, the monitor only needs to use an existing mobile terminal and a monitored person can use the monitored mobile terminal of the present disclosure, and then the monitoring function of this system can be accomplished by simply setting a mobile phone number or password of the monitor in the monitored mobile terminal. Therefore, the monitoring system for a mobile terminal and the monitoring method thereof according to the present disclosure are simple to operate and convenient to use.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A monitoring system for a mobile terminal, comprising:
a monitoring mobile terminal, being configured to send monitoring request information; and
a monitored mobile terminal, being configured to receive the monitoring request information and send a corresponding monitoring report to the monitoring mobile terminal according to the monitoring request information,
wherein the monitoring mobile terminal and the monitored mobile terminal are connected wirelessly.

2. The monitoring system for a mobile terminal of claim 1, wherein the monitored mobile terminal comprises:
an MSM module, being configured to set a sending format and a sending time of the monitoring report; and
an SSM module, being configured to modify the setting functions of the MSM module, and
the monitored mobile terminal is also configured to send the monitoring report to the monitoring mobile terminal periodically.

3. The monitoring system for a mobile terminal of claim 2, wherein the MSM module comprises:
a password control unit, being configured to set a mobile phone number or password of the monitoring mobile terminal; and
a password identifying unit, being configured to identify the mobile phone number or password.

4. The monitoring system for a mobile terminal of claim 2, wherein the monitoring mobile terminal comprises:
an MSM module, being configured to set a sending format and a sending time of the monitoring report; and
an SSM module, being configured to modify the setting functions of the MSM module.

5. The monitoring system for a mobile terminal of claim 1, wherein the monitoring report includes one or more of a calling party's phone number, a call duration, a short message record, a QQ chat log, a website and a networking times.

6. A monitoring method that uses the monitoring system of claim 1, comprising the following steps of:
sending monitoring request information by the monitoring mobile terminal to the monitored mobile terminal; and
receiving the monitoring request information and sending a corresponding monitoring report to the monitoring mobile terminal according to the monitoring request information by the monitored mobile terminal.

7. The monitoring method of claim 6, further comprising the following step before the monitoring mobile terminal sends the monitoring request information to the monitored mobile terminal:
setting a mobile phone number or password of the monitoring mobile terminal in the monitored mobile terminal.

8. The monitoring method of claim 7, further comprising the following step after the monitoring mobile terminal sends the monitoring request information to the monitored mobile terminal:
identifying the mobile phone number or password of the monitoring mobile terminal by the monitored mobile terminal.

9. The monitoring method of claim 6, wherein the monitoring report is sent to the monitoring mobile terminal in the form of a short message.

10. The monitoring method of any of claim 6 to claim 9, wherein the monitoring report includes one or more of a calling party's phone number, a call duration, a short message record, a QQ chat log, a website and a networking times.
